(19) United States
(12) Patent Application Publication
(10) Pub. No.: US 2023/0249904 A1
(43) Pub. Date: Aug. 10, 2023

(54) PORTABLE WASTE DISPOSAL BAG

(71) Applicant: 413 DUMPSTER INC., South Hadley, MA (US)

(72) Inventors: Waldemar Binczyk, South Hadley, MA (US); Alexander Binczyk, Ludlow, MA (US)

(73) Assignee: 413 DUMPSTER INC., South Hadley, MA (US)

(21) Appl. No.: 17/667,633

(22) Filed: Feb. 9, 2022

(51) Int. Cl. B65F 1/00; B65D 33/10; B65D 30/00

(52) U.S. Cl. CPC B65F 1/0006; B65D 33/105; B65D 29/00; B65F 2250/1146

(57) ABSTRACT

A portable waste disposal bag includes a generally round bottom section, and a generally cylindrical side section that encircles the bottom section and is attached by stitching to the bottom section. The bag also includes at least two lifting straps which are each attached by stitching to the side section. The bottom section, side section and the two lifting straps are each made from a single piece of flexible material such as woven polypropylene. The bottom section and side section form a primary waste holding section configured to hold waste products and which forms means for evenly distributing the weight of an aggregate amount of the waste products held in the primary waste holding section. The means for evenly distributing the weight is configured to be deformable into an overall generally round shape during lifting of the waste disposal bag off of a surface.

### FIELD OF THE INVENTION

The subject matter disclosed herein relates in general to portable waste disposal bags, and more specifically to a portable waste disposal bag that is relatively strong in construction, easy for someone to fill with trash or waste products, and quick and easy to safely remove once the bag has been filled.

### BACKGROUND OF THE INVENTION

Known, prior art portable waste disposal bags basically comprise relatively large flexible material bags that are foldable and collapsible in nature. These bags are commonly used for storage, handling, and transportation of junk, trash, garbage, or waste products such as home, garage, and shed structural products, furnishings, and objects resulting from projects such as inside or outside construction, renovations, re-modellings, or cleanouts, as well organic yard debris from clean-ups, and the like. The portable waste disposal bags are popular with home dwellers due to their low cost, wide range of placement locations at a fill site such as on a driveway or yard, and ease of filling and removal.

Also, the bags are typically purchased at retail locations and can be filled by the do-it yourselfer without the need to hire someone to fill it. Once filled, the bags are then usually removed by contacting a service to come and place the bag onto or into a truck for hauling away of the bag. The bags are a favored replacement for typically larger conventional metal dumpsters yet offer a greater amount of waste removal than normal trash removal services. These portable waste disposal bags provide a convenient way to get rid of unwanted household and yard waste.

These known, prior art portable waste disposal bags are typically rectangular in shape both for their sides and bottom. They also have a plurality of handles that facilitate lifting of the bag when partially or fully filled. The lifting is typically carried out by equipment such as the crane of a boom truck, a forklift, or some other machine, as part of the bag removal and waste disposal process.

However, rectangular-shaped bags suffer several drawbacks, including having a relatively large footprint at a fill site such as on a driveway or a yard surface. Also, the rectangular-shaped bag typically does not lend itself to a relatively even distribution of the weight of its contents, which could pose problems when lifting the relatively heavy bag (which can hold up to approximately 3,300 pounds) by the crane of the boom truck, the forklift, or by some other machine. These problems include, for example, not having the machine be able to lift the bag within its weight rating or having some of the waste products fall out of the bag.

Further, the rectangular-shaped bag of the prior art has angled corners inside the bag where the sidewalls meet. Also, oftentimes each of the rectangular sides is comprised of a single piece of the material, which then needs to be joined to each other and to the bottom piece. As such, the rectangular nature of the bag increases the likelihood that waste products placed inside the bag may encounter one or more of the angled corners and/or joints between pieces of material, which then increases the likelihood of the bag being ripped, torn, or otherwise damaged.

Thus, there is a need for improvements to a portable waste disposal bag, notably for a smaller footprint while on a hard surface (e.g., packed dirt or a paved driveway) or on a soft surface (e.g., sand or grass), as well as for a more even distribution of the weight of the contents of the bag when filled, and a reduction in the possibility of ripping, tearing, or damaging the material of the bag.

### BRIEF SUMMARY OF THE INVENTION

An object of embodiments of the present invention is to provide a portable waste disposal bag that is made from a relatively strong yet flexible, pliable, and collapsible material.

Another object of embodiments of the present invention is to provide a portable waste disposal bag that has a relatively small footprint while it is located at a fill site on a flat surface such as a paved driveway, dirt, sand, or grass.

Yet another object of embodiments of the present invention is to provide a portable waste disposal bag that can be folded into a generally flat and compact condition when empty.

Still another object of embodiments of the present invention is to provide a portable waste disposal bag that is relatively easy for a person to fill with different types of waste products.

Another object of embodiments of the present invention is to provide a portable waste disposal bag that is relatively easy to pick up and remove once it has been filled.

Yet another object of embodiments of the present invention is to provide a portable waste disposal bag having a round bottom and a cylindrical side and which provides for a relatively more even distribution of the weight of its contents.

According to an embodiment of the present invention, a portable waste disposal bag includes a generally round bottom section, and a generally cylindrical side section that encircles the bottom section and is attached by stitching to the bottom section. The bag also includes at least two lifting straps which are each attached by stitching to the side section. The bottom section, side section and the two lifting straps are each made from a single piece of flexible material such as woven polypropylene. The bottom section and side section form a primary waste holding section configured to hold waste products and which forms means for evenly distributing the weight of an aggregate amount of the waste products held in the primary waste holding section. The means for evenly distributing the weight is configured to be deformable into an overall generally round shape during lifting of the waste disposal bag off of a surface.

### BRIEF DESCRIPTION OF THE DRAWINGS

The subject matter, which is regarded as the disclosure herein of exemplary embodiments of the present invention, is particularly pointed out and distinctly claimed in the claims at the conclusion of this specification. The forgoing and other features and advantages of the present invention will become more apparent from the following detailed description taken in conjunction with the accompanying drawings in which:

FIG. 1 is a perspective view of a portable waste disposal bag according to an embodiment of the present invention;

FIG. 2 is a perspective view of the portable waste disposal bag of FIG. 1 taken from a different viewpoint as that of FIG. 1; and

FIG. 3 is a perspective view of the portable waste disposal bag of FIG. 1 when filled with waste products and in the process of being lifted by a machine.

### DETAILED DESCRIPTION OF THE INVENTION

It should be understood that, throughout this patent application and specifically in the written description that follows and in the accompanying drawing figures, various directional and orientational terms such as inside, outside, horizontal, vertical, up, down, upwardly, downwardly, front, back, top, bottom, upper, lower, left, right, and other similar terms as they are used herein refer to the portable waste disposal bag of the various exemplary embodiments of the present invention as that bag is oriented when it is typically placed on surface such as a driveway or grass for filling with waste products, and is lifted for removal by a crane of a boom truck, by a forklift, or by a similar machine. All of these terms are used in this written description and in the drawings for convenience only and as an aid to better understanding the exemplary embodiments of the present invention. These terms are not intended to be limiting in the claims appended hereto or to imply that the portable waste disposal bag must be used or positioned in any particular orientation.

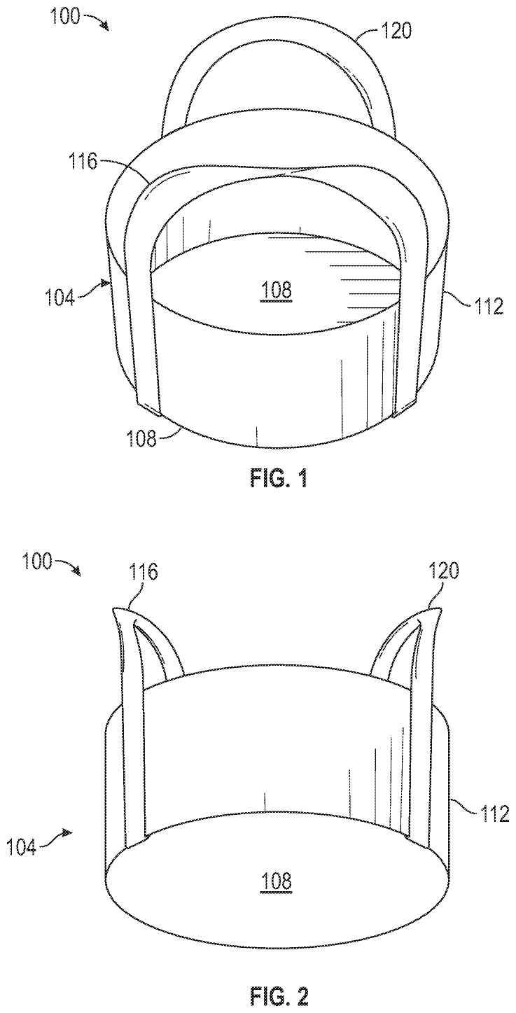

Referring to FIGS. 1 and 2, there illustrated are perspective views of a portable waste disposal bag 100 according to exemplary embodiments of the present invention. FIG. 2 illustrates the portable waste disposal bag 100 taken from a different perspective or viewpoint as that of FIG. 1.

In the exemplary embodiments of FIGS. 1 and 2, the portable waste disposal bag 100 comprises a primary waste holding section 104 that is cylindrical in its side shape and round in its bottom shape. As such, the portable waste disposal bag 100 of FIGS. 1 and 2 has an overall generally round shape as opposed to an overall generally rectangular shape as in the known portable waste disposal bags of the prior art. The primary waste holding section 104 includes a round bottom section 108 and a cylindrical side section 112. Each of the bottom and side sections 108, 112 may comprise a single piece of flexible and pliable yet strong material, such as woven polypropylene or other similar suitable material. The material utilized for these sections 108, 112 has a tensile strength sufficient to safely and securely hold a total weight of approximately 3,300 pounds or more of the aggregate amount of the waste products placed within the primary waste holding section 104 of the bag 100. The outer perimeter of the bottom section 108 may be attached or joined to the bottom perimeter of the cylindrical side section 112 by stitching or other suitable connection method. Thus, the cylindrical side section 112 encircles the round bottom section 108. Further, the flexible primary waste holding section 104 is collapsible as well as foldable.

The portable waste disposal bag 100 also includes a pair of lifting straps 116, 120 that are each attached to the bag 100 such that the straps 116, 120 are arranged opposite each other in parallel. This is done to facilitate the proper and safe lifting of the bag 100 when full of waste products for removal from the fill site and onto a truck for subsequent disposal of the products. The material of the lifting straps 116, 120 may comprise a relatively high-strength flexible woven polypropylene or other suitable strong flexible material similar to that of the bottom section 108 and the side section 112. The material of the lifting straps 116, 120 may be of a greater thickness than the material of the bottom section 108 and the side section 112.

In the exemplary embodiments of FIGS. 1 and 2, each lifting strap 116, 120 is continuous and is attached or joined by stitching to only the outside surface of the side section 112 and not also to the outside surface of the bottom section 108. Further, each lifting strap 116, 120 is attached to the outside surface of the side section 112 along the entire height of the side section 112, although this is not strictly necessary for the broadest scope of the present invention. A portion of each lifting strap 116, 120 extends above the top perimeter of the side section 112.

However, it is to be understood that the lifting straps 116, 120 instead may be attached to the inside surface of the side section 112 in accordance with the broadest scope of the present invention. As such, at least a portion of each strap 116, 120 may also be attached to the inside surface of the bottom section 108. Further, at least a portion of each lifting strap 112, 120 may be attached to the outside surface of the bottom section 108. All of these attachment variations are contemplated by the broadest scope of the present invention.

In an exemplary embodiment, the diameter of the round bottom section 108 may be approximately 78 inches, the height of the cylindrical side section 112 may be approximately 33 inches, the width of each of the lifting straps 116, 120 may be approximately 3.5 inches, and the portion of each lifting strap 116, 120 that extends above the top perimeter of the side section 112 may be approximately 40 inches. As such, the portable waste disposal bag 100 holds a maximum of approximately 3.3 cubic yards of waste products, which is a maximum of approximately 3,300 pounds. However, it should be understood that these dimensions for the bottom section 108, side section 112, and lifting straps 116, 120 are purely exemplary. Instead, any suitable desired dimensions for these components 108-120 of the bag 100 may be utilized within the broadest scope of the present invention in light of the teachings herein. The dimensions chosen for the various components 108-120 of the bag 100 may depend on the desired amount of total weight to be safely handled by the bag 100 or the desired total volume amount of waste products to be safely filled inside of the bag 100.

In use, the portable waste disposal bag 100 of the exemplary embodiments of the present invention may be purchased, for example, in person at a retail location, through an online retailer, or by some other method. The bag 100 as sold and transported or shipped may typically be in a folded condition, thereby saving space. The bag 100 may then be brought to a fill site, such as at a house or other building such as a garage or shed, or commercial building. The bag 100 may also be brought to a location apart from a building to be filled with organic yard waste (e.g., tree branches, leaves, etc.).

Once at the fill site, the bag 100 may be unfolded and filled with waste products. After unfolding, the bag 100 may initially be such that the side section 112 is in a collapsed condition. Then after the filling of the bag 100 with waste products begins, the side section 112 may start to assume an upright vertical position such that the bag 100 can support itself in maintaining an upright and open condition. Also, during the filling process, care is generally taken to ensure that the flexible lifting straps 116, 120 are located outside of the primary waste holding section 104 of the bag 100. This allows for proper and easy access to the straps 116, 120 when it is time later on to remove the bag 100 from the fill site.

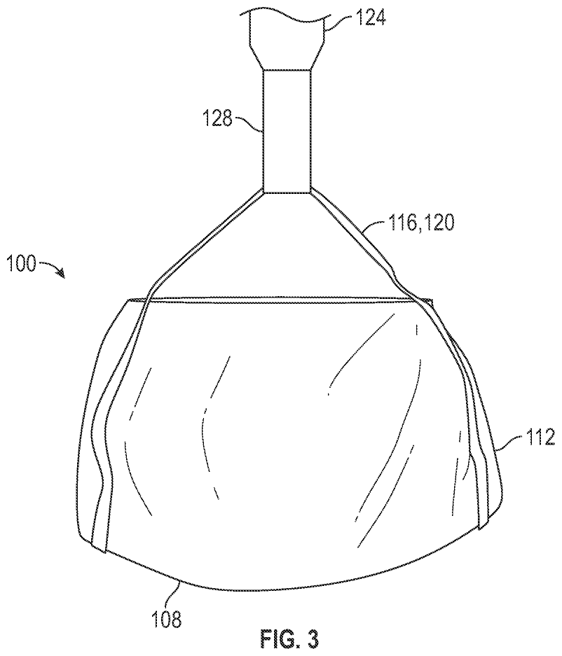

Referring to FIG. 3, there illustrated is the portable waste disposal bag 100 of FIGS. 1 and 2 when filled at least to some extent with waste products and in the process of being lifted by a crane 124 of a boom truck (not shown). More specifically, FIG. 3 illustrates a portion of the crane 124 having a flexible strap or a rigid hook 128 that attaches to both of the lifting straps 116, 120. The bag 100 is lifted away (i.e., raised) from the fill site and is placed (i.e., lowered) onto the boom truck or another vehicle for removal and subsequent disposal of the waste products inside the bag 100. Instead of a crane 124 of a boom truck, the bag 100 may be removed from the fill site using a forklift or other suitable machine. When a forklift is used to remove the filled bag 100 from the fill site, the forks or tongs of the forklift engage with the lifting straps 116, 120 to transport the bag 100 to a desired location.

As best seen in FIG. 3, when the portable waste disposal bag 100 is filled with waste products and is lifted away from the fill site, the generally round shape of the bag 100 is dynamically deformed somewhat by the waste products inside the bag 100. However, the bag 100, while deformed, still maintains its overall generally round shape throughout the lifting process. This is due primarily to the flexible nature of the material comprising the bottom section 108, side section 112, and lifting straps 116, 120. As such, the generally round shape of the bag 100 provides for a relatively more even distribution of the weight of its contents, which is in contrast to the rectangular shape of known, prior art waste disposal bags. This more even weight distribution provided by the bag 100 allows for increased safety when lifting the relatively heavy (greater than one ton) bag by the crane of a boom truck, a forklift, or other machine. It also prevents the waste products from falling out of the bag 100.

Other advantages that the portable waste disposal bag 100 of the exemplary embodiments of the present invention has over known, similar waste disposal bags of the prior art include that the generally round shape of the bag 100 provides for a smaller footprint when the bag 100 is located on a hard surface (e.g., packed dirt or a paved driveway) or on a soft surface (e.g., sand or grass). This allows the bag 100 to be utilized in physical spaces that are relatively small or confining. Further, the round shape of the bag 100 eliminates the corners found in prior art rectangular bags, thereby reducing the risk that waste products placed inside the bag 100 will rip, tear, or otherwise damage the bag 100.

The terminology used herein is for the purpose of describing particular embodiments of the present invention only and is not intended to be limiting of the present invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present invention is provided in detail in connection with only a limited number of embodiments, it should be readily understood that the present invention is not limited to such disclosed embodiments. Rather, the present invention can be modified to incorporate any number of variations, alterations, substitutions, or equivalent arrangements not heretofore described, but which are commensurate with the spirit and scope of the present invention. Additionally, while various embodiments of the present invention have been described, it is to be understood that the exemplary embodiments may include only some of the described exemplary aspects. Accordingly, the present invention it not to be seen as limited by the foregoing description but is only limited by the scope of the appended claims.

1. A portable waste disposal bag, comprising:
a generally round bottom section;
a generally cylindrical side section that encircles the bottom section and is attached to the bottom section; and
at least two lifting straps, each of the lifting straps being attached to the side section;
wherein a height of the side section is less than a diameter of the bottom section thereby defining an aspect ratio of the height of the side to the diameter of the bottom section, wherein the aspect ratio is less than 1.0.

2. The portable waste disposal bag of claim 1, wherein the bottom section comprises a single piece of flexible material.

3. The portable waste disposal bag of claim 2, wherein the single piece of flexible material comprises a woven polypropylene.

4. The portable waste disposal bag of claim 1, wherein the side section comprises a single piece of flexible material.

5. The portable waste disposal bag of claim 4, wherein the single piece of flexible material comprises a woven polypropylene.

6. The portable waste disposal bag of claim 1, wherein each lifting strap comprises a single piece of flexible material.

7. The portable waste disposal bag of claim 6, wherein the single piece of flexible material comprises a woven polypropylene.

8. The portable waste disposal bag of claim 1, wherein the side section is attached to the bottom section by stitching.

9. The portable waste disposal bag of claim 1, wherein each of the lifting straps is attached to the side section by stitching.

10. The portable waste disposal bag of claim 1, wherein each of the lifting straps is attached to an outside of the side section.

11. The portable waste disposal bag of claim 1, wherein the lifting straps are attached to an outside of the side section in an orientation wherein the lifting straps are disposed parallel to each other.

12. The portable waste disposal bag of claim 1, wherein a portion of each of the lifting straps extends above an upper perimeter of the side section.

13. The portable waste disposal bag of claim 1, wherein the bottom section and the side section comprise a primary waste holding section that is configured to hold waste products.

14. The portable waste disposal bag of claim 1, wherein the bottom section and the side section comprise a primary waste holding section that is configured to hold waste products, the primary waste holding section comprising means for evenly distributing the weight of an aggregate amount of the waste products held in the primary waste holding section.

15. The portable waste disposal bag of claim 14, wherein the means for evenly distributing the weight of the aggregate amount of waste products held in the primary waste holding section is configured to be deformable into an overall generally round shape during lifting of the waste disposal bag off of a surface.

16. The portable waste disposal bag of claim 1, wherein each of the bottom section, the side section and the lifting straps is comprised of a flexible material, wherein the portable waste disposal bag is configured and operable to be foldable and collapsible when empty, and wherein the side section is configured and operable to be upright when the portable waste disposal bag is filled with waste products.

17. A portable waste disposal bag, comprising:
a generally round bottom section that comprises a single piece of a flexible material;
a generally cylindrical side section that encircles the bottom section and is attached to the bottom section, the side section comprises a single piece of a flexible material; and
at least two lifting straps, each of the lifting straps being attached to the side section, each of the lifting straps comprises a single piece of a flexible material;
wherein a height of the side section is less than a diameter of the bottom section thereby defining an aspect ratio of the height of the side section to the diameter of the bottom section, wherein the aspect ratio is less than 1.0 and more particularly less than 0.5;
wherein the bottom section and the side section comprise a primary waste holding section that is configured to hold waste products, the primary waste holding section comprising means for evenly distributing the weight of an aggregate amount of the waste products held in the primary waste holding section; and
wherein the portable waste disposal bag is configured and operable to be foldable and collapsible when empty, and wherein the side section is configured and operable to be upright when the portable waste disposal bag is filled with waste products.

18. The portable waste disposal bag of claim 17, wherein the means for evenly distributing the weight of the aggregate amount of waste products held in the primary waste holding section is configured to be deformable into an overall generally round shape during lifting of the waste disposal bag off of a surface.

19. The portable waste disposal bag of claim 17, wherein the flexible material comprises woven polypropylene.

20. The portable waste disposal bag of claim 17, wherein the side section is attached to the bottom section by stitching, and wherein each of the lifting straps is attached to the side section by stitching.
